(19) United States
(12) Patent Application Publication
(10) Pub. No.: US 2006/0286852 A1
(43) Pub. Date: Dec. 21, 2006

(54) Power connector with ID identifying member

(75) Inventor: Peter Kuo, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/471,430

(22) Filed: Jun. 20, 2006

(30) Foreign Application Priority Data
Jun. 21, 2005 (CN) 200520073035.4

(51) Int. Cl. H01R 3/00

(52) U.S. Cl. 439/488

(57) ABSTRACT

A power connector (100) is adapted for connecting with a power input port of an electrical device and includes an insulative housing (1), first and second terminals (2, 3) received in the housing for power transmission, a third terminal (4) received in the housing for signal transmission and a resistor (50) having certain resistance detectable by the electrical device electrically connecting with the second and third terminals. The first and second terminals respectively served as a positive pole and a negative pole of the power connector.

### CROSS-REFERENCE TO RELATED APPLICATION

Subject matter of this application is related to a copending application entitled “POWER CONNECTOR HAVING REGULATING MEMBER” which is invented by Peter Kuo and assigned to the same assignee as this application.

### BACKGROUND OF THE INVENTION

1. Field of the Invention

The present invention relates to an electrical connector, more particularly to a power connector for power transmission.

2. Description of Related Art

Power jacks/plugs are widely used in the electrical industry to connect power supplies with electrical devices, such as mobile phone, note book. The power connector commonly comprises a dielectric housing, an inner contact and an outer contact respectively served as a positive pole and a negative pole of a power supply for powering electrical device connecting with the power connector, and a signal contact provided for signal transmission. The power connectors are classified in many types by specific work voltage thereof, such as 5V, 12V etc, so as to adapt for different applications. However, the outer profiles and the appearance of the power connectors of different types unmatched are similar, therefore, it is possible that the user inserts a power connector to a complementary connector unmatched with the power connector, which results in destroying performance and useful life of the power connector as well as an electrical component to which the complementary connector is assembled to.

Hence, an improved power connector is desired to overcome the disadvantages of the related art.

### SUMMARY OF THE INVENTION

Accordingly, an object of the present invention is to provide a power connector which could be identified by an electrical component to which the power connector is connected with the electrical component whether the power connector matches.

In order to achieve the object set forth, a power connector in accordance with the present invention is adapted for connecting with a power input port of an electrical device and comprises an insulative housing, first and second terminals received in the housing for power transmission, a third terminal received in the housing for signal transmission and a resistor having certain resistance detectable by the electrical device electrically connecting with the second and third terminals. The first and second terminals respectively served as a positive pole and a negative pole of the power connector.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a power connector in accordance with the present invention;

FIG. 2 is a view similar to FIG. 1, but viewed from another aspect;

FIG. 3 is an explored, perspective view of FIG. 2; and

FIG. 4 is a cross-sectional view of FIG. 2 along line 4-4.

### DETAILED DESCRIPTION OF THE INVENTION

Reference will now be made in detail to the preferred embodiment of the present invention.

Referring to the drawings in greater detail, the power connector 100 in accordance with the present invention matable with a complementary connector, comprises a generally cylindrical insulative housing 1, a pipe shape first terminal 2 assembled within the housing 1, a second pipe-shape terminal 3 sheathing over the housing 1, a third terminal 4 positioned in the center of the housing 1 and a identifying member 5 connecting with the first and third terminals 2, 4.

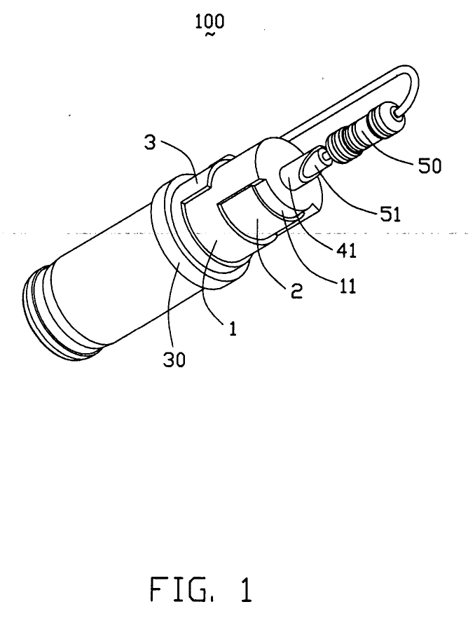

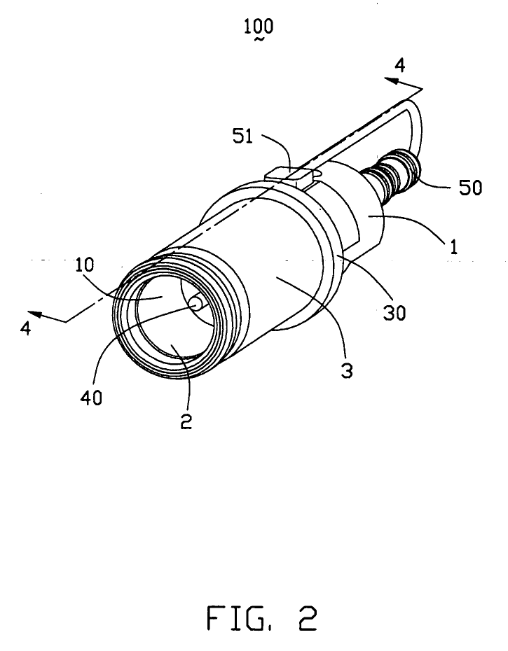

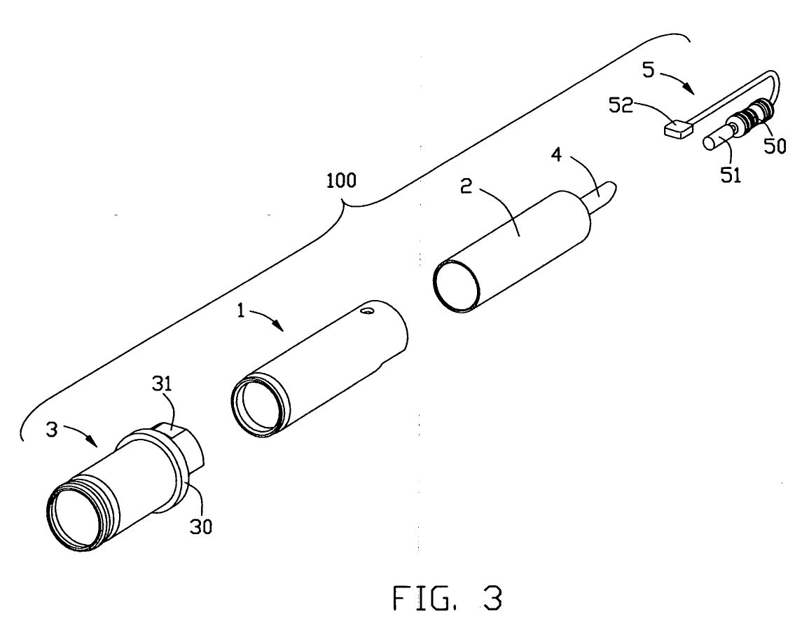

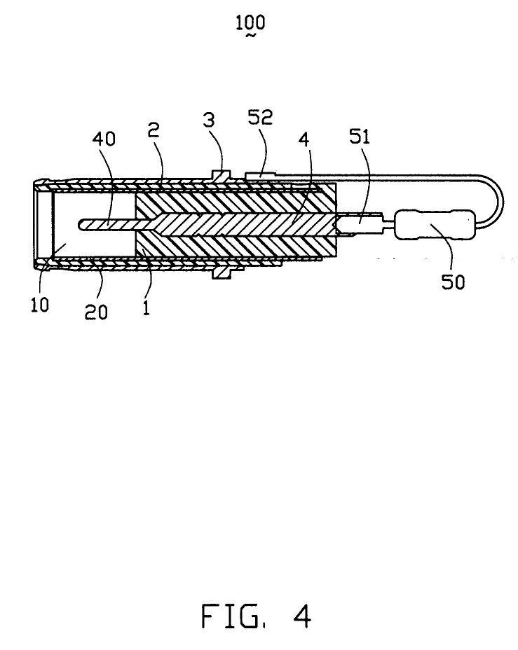

Also referring to FIGS. 1-4, the housing 1 is made of synthetic resin by insert molding. The housing 1 defines a receiving cavity 10 at a front portion thereof and a rear cutout 11 partially exposing the first terminal 2. The first and second terminals 2, 3 are configured in metal sleeves with different diameters. The first terminal 2 is functioned as a positive pole of the power connector 100, with front portion thereof attached to an inner surface of the receiving cavity 10 to form a contacting portion 20 contacting with a corresponding portion of the complementary connector. The second terminal 3 is served as a negative pole and comprises a rear annular portion 30 protruding outwardly from outer periphery thereof, a cupulate tail portion (not labeled) rearwardly extending from the annular portion 30 and a flat soldering portion 31 formed on the tail portion. The third terminal 4 is used for signal transmission. The third terminal 4 comprises a contacting portion 40 protruding into the receiving cavity 10 and a U-shaped cupulate connecting portion 41 rearwardly extending from the contacting portion 40 and exposed beyond the housing 1. The identifying member 5 comprises a first column-shape connecting section 51 received in and soldered with the connecting portion 41 of the third terminal 4, a second flat-shape connecting section 52 soldering to the soldering portion 31 of the second terminal 3 and a resistor 50 connecting with the first and second sections 51, 52.

The power connector 100 further comprises a cable (not shown) having a plurality of conductors (not shown) respectively connecting to the first, second and third terminals 2, 3, 4 and an insulating cover (not shown) partially covering the housing 1.

Since the resistor 50 is electrically connected with the negative pole/second terminal 3 and the center third terminal 4, the resistor 50 actually is functioned as a pull down resistor, that is to say, to change resistance of the resistor 50 could change the voltage of the third terminal 4 relative to a ground. When the power connector 100 is mated with the complementary connector, the electrical component with the complementary connector assembled thereon will detect the voltage of the third terminal 4 to identify whether the power connector 100 is the matching type, if not, the electrical component will not run to avoid any undesired impact.

In alternative embodiment, the resistor 50 also can be replaced by other elements, such as capacitor etc. provided for realizing the same function as that of 50.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power connector adapted for connecting with a power input port of an electrical device, comprising
an insulative housing;
first and second terminals received in the housing for power transmission, the first and second terminals respectively served as a positive pole and a negative pole of the power connector;
a third terminal received in the housing for signal transmission; and
an identifying member electrically connecting with the second and third terminals and having certain resistance detectable by the electrical device for identifying whether the power connector is the right type matched with the complementary connector.

2. The power connector as claimed in claim 1, wherein the identifying member comprises a resistor and a pair of first and second connector sections connecting with the resistor, and wherein the first and second connecting sections respectively connect with the second and third terminals.

3. The power connector as claimed in claim 1, wherein the housing defines a front receiving cavity for receiving corresponding portion of the complementary connector.

4. The power connector as claimed in claim 3, wherein the first terminal is attached to the housing with front contacting portion thereof exposed is the receiving cavity.

5. The power connector as claimed in claim 1, wherein the housing defines a rear cutout partially exposing the first terminal to outside.

6. The power connector as claimed in claim 3, wherein the third terminal comprises a contacting portion protruding into the receiving cavity of the housing and a connecting portion extending beyond the housing to electrically connecting with the resistor.

7. The power connector as claimed in claim 2, wherein the third terminal is positioned in the center of the housing and the connecting portion thereof shaped as a U-shaped cup, and wherein the first connecting section of the identifying member is column shape to be received in and soldered with the connecting portion of the third terminal.

8. The power connector as claimed in claim 2, wherein the second terminal is a metal sleeve sheathing over the housing.

9. The power connector as claimed in claim 2, wherein the second terminal comprises an annulus portion and a tail portion rearwardly extending from the annulus portion.

10. The power connector as claimed in claim 9, wherein the second connecting section of the identifying member is soldered with the tail portion of the second terminal.

11. The power connector as claimed in claim 1, wherein the power connector is connectable with a cable.

12. The power connector as claimed in claim 1, wherein the insulative housing, the first and second terminals are column shape.

13. The power connector as claimed in claim 2, wherein the value of the resistor of the identifying member is changeable.

14. A power connector comprising:
an insulative insulative housing;
a power contact disposed on one side of the housing;
a grounding contact disposed on the other side of the housing and isolated from the power contact with the housing; and
a signal contact spaced from the power contact while electrically connected to the grounding contact via an electronic component which performs an identifiable substantial voltage drop phenomenon between the signal contact and the grounding contact so as to allow a complementary connector may identify whether the power connector is a right type for mating.

15. The power connector as claimed in claim 14, wherein all power contact, the grounding contact and the signal contact are coaxially arranged with one another.

16. The power connector as claimed in claim 14, wherein said electronic component is a resistor.

17. The power connector as claimed in claim 14, wherein said signal contact is located within the power contact.

18. The power connector as claimed in claim 14, wherein said a connection between the grounding contact and the signal contact defines a U-shaped configuration.

19. A method of detecting a power connector, comprising steps of:
providing a power connector with power, signal and grounding contacts spaced from one another;
providing an insulative housing to isolate the power contact from the grounding contact; and
electrically connecting said signal contact to said grounding contact via an electronic component; wherein
said electronic component experiences an energy change so as to change the output signal of the signal contact.

20. The method of claim 19, wherein said signal contact performs a specific voltage level according to a property of said electronic component.
